(19) United States
(12) Patent Application Publication
(10) Pub. No.: US 2025/0037219 A1
(43) Pub. Date: Jan. 30, 2025

(54) METHOD, DEVICE, AND STORAGE MEDIUM FOR TOURISM SERVICES

(71) Applicant: Wei Liao, Wilton, CT (US)

(72) Inventor: Wei Liao, Wilton, CT (US)

(73) Assignee: Wei Liao, Wilton, CT (US)

(21) Appl. No.: 18/360,767

(22) Filed: Jul. 27, 2023

(51) Int. Cl. G06Q 50/14; G06Q 50/00

(52) U.S. Cl. CPC G06Q 50/14; G06Q 50/01

(57) ABSTRACT

An innovative system is introduced to elevate the tourist experience, offering a single, comprehensive platform for pre-trip planning, on-site photo capturing, and during or post-trip sharing. Users can customize their itinerary through an intuitive interface, prompting the server to supply extensive information on the selected attractions, including detailed descriptions, photography guidance, and social content creation tips. Pre-trip, tourists are equipped with thorough knowledge about their tourist attractions, enhancing preparation and anticipation. During the journey, users receive on-the-spot photography guidance to maximize experience capture. During or post-trip, the system eases the process of sharing the journey across platforms. This holistic approach amplifies understanding of chosen attractions, improves documentation of experiences, and facilitates effortless sharing, profoundly augmenting the tourism experience.

### TECHNICAL FIELD

This application pertains to the field of data processing technology, especially a method, device, and storage medium for tourism services.

### BACKGROUND

The processes of travel planning, photo capturing, and social media sharing can often be intricate and labor-intensive, involving substantial research before, during, and after a journey. This intricacy may lead travelers to overlook worthwhile opportunities or face hurdles that negatively impact the overall travel experience. Hence, there's a pressing need for an enhanced travel service that streamlines travel preparation, photo taking, social platform sharing, and thereby, significantly uplifts the quality of the travel experience.

### SUMMARY

A tourism service system is introduced to enhance tourism experiences through an implemented method, device, and storage medium. The system provides users with customized attraction descriptions, photography guidance for hotspots, and content creation assistance for social media.

On the server-side, the method operates by:

1. Receiving a travel service request initiated by a user including selected tourist attractions.

2. Accessing a database of attraction attributes and features to generate detailed descriptions for each selected attraction. Descriptions are designed to familiarize users prior to traveling.

3. Analyzing hotspot data and photography trends to identify optimal hotspots and perspective for photographic opportunities within each attraction. Photography guidance is then generated.

4. Creating engaging social media content during or after the trip tailored to the user type and selected attractions.

5. Transmitting the generated information including attraction descriptions, photography guidance, and social media content guidance to the user's device.

On the user-side, the method enables:

1. Displaying an intuitive travel service interface on a user's device.

2. User interaction with the interface to select attractions and input details like user type. This generates a tailored travel service request.

3. Sending the request to the server which triggers generation of personalized information and guidance.

4. Receiving the generated descriptions, photography guidance, and content creation assistance from the server and displaying them on the user's travel service interface.

The system architecture includes:
User devices like smartphones with the travel service interface.
A server with storage, a processor, and communication components.
A database storing attraction attributes and features.
A computer-readable medium with instructions to implement the method.

In summary, this system elevates tourism experiences by providing users with comprehensive and personalized information on selected attractions along with photography and social media content creation guidance tailored to their trip parameters. The method and architecture enable enhanced end-to-end tourism services.

### BRIEF DESCRIPTION OF DRAWINGS

In order to describe the technical solutions in the embodiments of the present disclosure or the prior art more clearly, the drawings required to be used for descriptions about the embodiments or the prior art will be simply introduced below. It is apparent that the drawings described below are some embodiments of the present disclosure. Those of ordinary skill in the art may further obtain other drawings according to these drawings without creative work.

FIG. 1 is a structural diagram of a tourism service system as proposed by a sample embodiment of the application;

FIG. 2 is a logic diagram of an optimization scheme provided by an exemplary embodiment of the present application;

FIG. 3 illustrates generating personalized destination information, shooting guide information, and social content information using AI models. Reference data is collected and annotated. Instructions are configured based on templates for the destination type and tourist persona;

FIG. 4 is a flow chart of a method for the server to provide travel services, including receiving a request, determining the destination, generating tailored information using AI models, and sending the information to the user device;

FIG. 5 illustrates a flowchart of a different tourism service method offered by yet another sample embodiment of the application;

FIG. 6 depicts a structural diagram of a computing device provided by another exemplary embodiment of the application; and

FIG. 7 is a structural diagram of a different computing device provided by another sample embodiment of the application.

### DESCRIPTION OF EMBODIMENTS

Implementations of the present disclosure will be described in detail below with reference to the accompanying drawings and embodiments, so that the implementation process of solving the technical problem by applying the technical means and achieving technical effect can be fully understood and implemented.

Certain terms used throughout the description and claims are used to refer to particular components. Those skilled in the art will understand that hardware manufacturers may call the same component by different nouns. The present description and claims do not use a name difference as a mode for distinguishing the components, but the functional difference of the components is taken as a criterion for distinguishing. The word “comprising” as used throughout the description and claims is an open term and should be interpreted as “comprising but not limited to”. “Substantially” means that within an acceptable error range, those skilled in the art will be able to solve the technical problems within a certain error range, basically achieving the technical effects. In addition, the term “coupled” is used herein to include any direct and indirect electrical coupling means. Therefore, if it is described here that a first apparatus is coupled to a second apparatus, it is indicated that the first apparatus may be directly and electrically coupled to the second apparatus or indirectly and electrically coupled to the second apparatus through other apparatuses or coupling means. The description is described as an implementation mode for implementing the present disclosure. However, the description is intended to be illustrative of the general principle of the present disclosure, and is not intended to limit the scope of the present disclosure. The scope of protection of the present disclosure is subject to the definition of the appended claims.

It is also to be noted that terms “include”, “contain” or any other variants thereof are intended to include nonexclusive inclusions, thereby ensuring that a commodity or system including a series of elements not only includes those elements but also includes other elements which are not clearly listed or further includes elements intrinsic to the commodity or the system. Under the condition of no more restrictions, an element defined by statement “including a/an” does not exclude the existence of another element which is the same in a commodity or system including the element.

### Specific Embodiments

Travel planning and execution can be complex, discouraging tourists and leading to poor experiences from lack of knowledge. This invention addresses that through an intuitive travel service platform.

Users select destinations on their device, sending a request to the server. In response, the server generates and sends back personalized information about the sites. This includes descriptions, photography guidance, and social media content suggestions, meeting the user's needs.

So with simple destination configuration, users get comprehensive details to learn about attractions before visiting. They receive photography tips to capture better images on location. They also get ideas to create engaging social media content during or after the trip.

In total, this one-stop tourism service enhances travel understanding, improves photo quality, and simplifies sharing. Users are equipped with thorough and objective knowledge beforehand, aided in producing captivating photographs, and inspired to effortlessly share their journeys online. The overall tourism experience is significantly elevated.

The following sections cover specific system embodiments and process flows, using diagrams, to demonstrate the innovations in more concrete detail. It should be noted these examples represent only some possibilities, and experts may derive other embodiments that also fall under the protective scope of the patent.

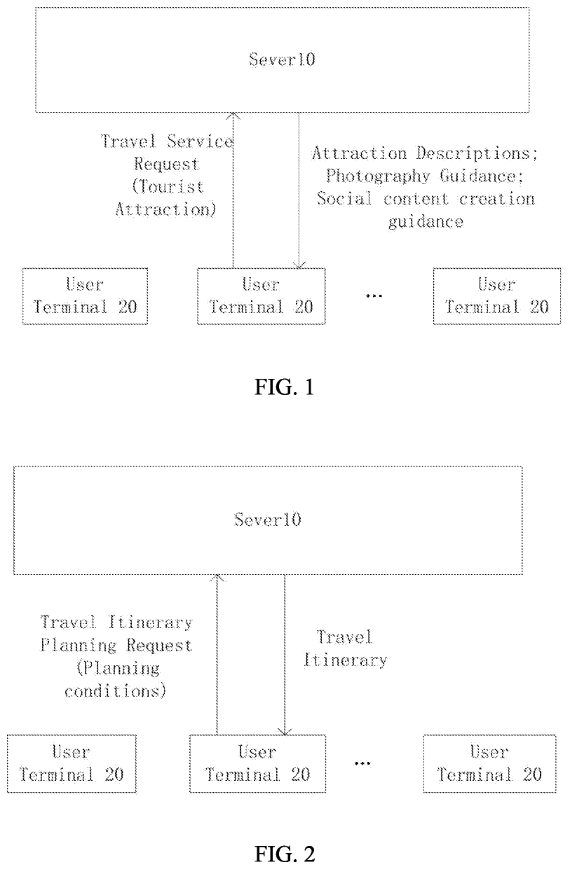

FIG. 1 presents a schematic diagram of a tourism service system as demonstrated in an exemplary embodiment of this patent application. As seen in the figure, the system includes a server (10) and a user terminal (20), both connected through a communication medium.

The tourism service method provided in this embodiment can be applied in various tourism-related application scenarios, and this embodiment does not limit the application scenarios. The tourism service method provided in this embodiment can be implemented independently, or it can be embedded into various existing tourism products as a new product component for implementation, and this embodiment does not limit this.

Physically, the user terminal (20) can be devices like a personal computer, smartphone, tablet, etc., while the server (10) can be conventional servers, cloud servers, etc. The server primarily comprises components such as processors, hard drives, memory, system buses, akin to a typical computer architecture. The server (10) can also be implemented as a server cluster, among other configurations, without any limitations.

For instance, the user terminal (20) can be established as a cloud server cluster, utilizing distributed technology for computing and storage. Additionally, microservice technology can be deployed in the cloud server cluster to implement relevant functions of the user terminal in this embodiment. This technology can split a single application into a set of smaller services, which coordinate and cooperate to deliver final value to the user. Each service operates in its independent process, communicates using lightweight mechanisms, and is constructed around specific functional requirements. In the cloud server cluster, container orchestration technologies such as Kubernetes can be used for the deployment and scheduling of microservices. Of course, this embodiment is not limited to this.

The user terminal (20) might have a client installed to support travel services. This client could take various forms such as a web version, mini program, app version, etc., without any constraints. The client in the user terminal (20) can provide a travel service interface.

With this setup, for the user terminal (20), a travel service interface can be displayed. Users can execute a travel site configuration operation in this interface. Consequently, the user terminal (20) can generate a travel service request in response to the user executing the travel site configuration operation in the travel service interface. The travel service request contains the travel sites selected by the user.

In practical applications, the user terminal (20) can adopt several implementation methods to support users in performing travel site configuration operations. Here are a few examples:

1. Method one: A travel site input control can be displayed in the travel service interface. The user's input operation executed on this control can be considered as a travel site configuration operation.

2. Method two: The server (10) can use the travel service interface to display pushed information to users. The user's site selection operation executed in this push information can be considered as a travel site configuration operation.

3. Method three: The user terminal (20) can send a request to call the travel map component to the server (10), and display the travel map page provided by this component through the travel service interface. The user's site selection operation executed on the travel map page can be seen as a travel site configuration operation. Preferably, the server (10) can also separately determine popularity levels for preset sites. Sites with different popularity levels can be distinctly marked in the travel map component, allowing for differentiation through the travel map page when the user terminal calls the travel map component. Optionally, sites can be categorized into different popularity levels, such as low, medium, and high, with ‘high’ being the highest popularity level. This way, the methodology can classify travel sites into different popularity tiers and, by distinguishing sites within these tiers, present these sites to users with varying degrees of prominence. This allows users to locate their required travel sites more quickly and accurately, indirectly achieving site recommendation functionality. As an example, the site's popularity index can be obtained by counting factors such as the number of comments, rating, traffic, visit times, etc. This is just an example, and other schemes can be used in this embodiment to determine the popularity level of each site.

In practical applications, various methods can be used to distinguish markings, such as setting different display colors or varying the size of display icons for different popularity levels. For example, sites with a higher popularity level might be represented with a more vibrant display color. The highest popularity level site could be represented with a red icon, the next popularity level with a blue icon, and so on.

It should be understood that these implementation methods are merely examples, and this embodiment is not limited to them. Moreover, the user terminal (20) can simultaneously support several such example implementation methods, and it can certainly also support more.

In this manner, users can initiate the generation of travel service requests through simple travel site configuration operations. Compared to traditional methods, users no longer need to perform a multitude of information retrieval operations on multiple websites. This significantly enhances the convenience of travel services and improves the user experience.

On this foundation, the user terminal (20) can send the generated travel service request to the server (10). For the server (10), it can respond to the travel service request initiated by the user terminal (20) and identify the travel sites requested by the user. As mentioned earlier, the travel service request contains the travel sites selected by the user. Therefore, the server (10) can efficiently identify the travel sites requested by the user from the travel service request.

The server (10) can generate several types of service feedback information for the user regarding the travel sites:

1. It can create site description information for the user based on the attribute information of the travel site, allowing the user to understand the travel site before the start of the trip.

2. It can generate photography guidance information for the user for the hotspot shooting locations in the travel site, guiding the user to take photos at these hotspot locations during the trip.

3. It can generate social content creation guidance information for the user regarding the travel site, guiding the user to create targeted social content corresponding to the travel site during or after the trip.

The specific approach for the server (10) to generate site description information, shooting guidance information, and social content creation guidance information will be detailed later. In this embodiment, site description information may include, but is not limited to, basic information, cultural knowledge, fun facts, travel tips, user reviews, recent activity information, and nearby locations. Shooting guidance information may include items like landmark names, ideal shooting times, and shooting tips. Social content creation guidance information might include video titles & thumbnails, video scripts, content titles, tweet scripts, blog scripts, and hashtags. A video script might detail the duration of each video segment, provide voice-over scripts for each segment, or describe the transitions between adjacent video segments.

As seen in FIG. 1, the server (10) can also send the generated site description information, shooting guidance information, and social content creation guidance information to the user terminal (20) based on the user's needs, allowing the user to view this information on demand.

It should be understood that server (10) and user terminal (20) can cooperate to deliver and display the generated site description information, shooting guidance information, and social content creation guidance information as per the user's needs. In one practical example, the travel service request may also include the type of service feedback information selected by the user. In such a case, the server (10) would only send the selected service feedback information to the user terminal (20).

In another practical example, the server (10) can send all generated site description information, shooting guidance information, and social content creation guidance information to the user terminal (20). On the user terminal (20), the user can trigger the display of the selected service feedback information by selecting it within the travel service interface. For instance, different types of service feedback information might be displayed in the travel service interface, each corresponding to its own information page control. The user can execute a click operation on the information page control to trigger the display of the service feedback information corresponding to the clicked information page control, allowing the user to switch between the displays of multiple types of service feedback information.

In this embodiment, the site description information, shooting guidance information, and social content creation guidance information generated for the user regarding the travel site could be in the form of text, graphics and text, or video narration. The embodiment does not limit the form of information. The user terminal (20) can respond to the user-initiated display triggering operation for social content creation guidance information, displaying social content creation guidance information on the travel service interface. The user can also execute text copy operations on the social content creation guidance information in the travel service interface. This way, the user can copy the text content of the social content creation guidance information to a social content creation platform, aiding the user in the creation of social content. The social content creation guidance information can provide inspiration for users, reducing the creative thinking pressure when users create social content. Of course, in practical applications, users can draw inspiration from the social content creation guidance information, directly use the text provided in the social content creation guidance information, or make minor adjustments or recreate the text provided in the social content creation guidance information before applying it to social content. This embodiment does not limit this.

In this embodiment, besides generating site description information, shooting guidance information, and social content creation guidance information for the user for the requested travel site, the server (10) can also provide push information to the user.

In one example of a push scheme: The server (10) can determine the user type and geographic location corresponding to the user. Based on the user type and geographic location, it can determine the target site of interest to the user from among multiple pre-set settings. The server (10) can generate push information for the user for the target site and push this information to the user terminal (20) for display.

In this push scheme, the user terminal (20) could locate the user to determine the user's geographic location and provide this information to the server (10). Alternatively, the user terminal (20) can specify its own user type in the travel service request for the server (10) to determine the corresponding user type. The server (10) could also determine the corresponding user type based on the user's historical behavior, registration information, and other user profile data. This embodiment does not limit this. The user type in this implementation could include, but is not limited to, single, couple, family, nature enthusiast, or humanities enthusiast, etc. The user's target site of interest could be selected from multiple settings within the state where the user is located or from multiple settings within a range of N kilometers around the user's coordinate location.

Generally, the target attractions determined based on the user type and geographic location are cultural attractions or city exploration attractions. However, in this push scheme, the server can also select recommended attractions from natural attraction types, generate push information for these recommended attractions, and push this information to the user terminal used by the specified user for display. This user could be all users or some users. In practical applications, recommended attractions could be randomly selected from all natural attraction types; natural scene attractions could also be ranked, with the recommended attractions for each round determined in order; the selection of recommended attractions could also be based on references such as seasons. This embodiment does not limit this.

In this push scheme, the content contained in the push information for attractions under different tourist attractions types may not be exactly the same. The tourist attractions types in this implementation could include, but are not limited to, natural scene attraction, culture landscape, or city exploration, etc. For instance: If the tourist attractions type corresponding to the attraction is natural scene attraction, historical anecdotes and/or famous quotes related to the attraction could be included in the corresponding push information; If the tourist attractions type corresponding to the attraction is culture or city exploration, the description information of recommended activities and/or introduction information for the attractions could be included in the corresponding push information.

Thus, by proactively providing push information to users, it is possible to recommend attractions and stimulate the user's interest in travel more effectively.

As can be seen, in this embodiment, the user can simply configure the tourist attractions in the user terminal, and then trigger the server to generate the scenic spot description information, shooting guidance information and social content creation guidance information for the specified tourist spots. This allows users to thoroughly understand the tourist attractions before traveling, to better prepare and enhance anticipation, to get on-site shooting suggestions during the trip, thereby achieving better shooting effects, and to provide creative inspiration for user social sharing during or after the trip, thereby simplifying the social sharing process. Based on this, in this embodiment, a one-stop travel service can be provided to users, enhancing the understanding of tourist spots, improving the shooting experience of tourist spots and promoting easy sharing, thereby effectively improving the travel experience.

FIG. 2 is a logical schematic diagram of an optimization scheme provided by an exemplary embodiment of this application. Referring to FIG. 2, in addition to supporting feedback to the user about the scenic spot description information, shooting guidance information, and social content creation guidance information for the tourist spots requested by the user, this embodiment also supports the user triggering a tourist route planning request in the user terminal 20. The tourism route planning request may include planning conditions configured by the user. The planning conditions may include, but not limited to, one or more conditions of attraction type, user type, geographical area, attractions visited and travel duration. In actual applications, the geographical area can be a state area or a city area, etc. Based on this, server 10 can generate a tourist route for the user based on the planning conditions. It is worth noting that in the travel route planning service provided by this embodiment, the user does not need to specify the tourist attractions, but can provide at least one combination of tourist attractions that meets the planning conditions according to the user-configured attraction type, geographical area, etc., and provide route planning for the combination of tourist attractions. Optionally, in this embodiment, an AI model can be used to generate a tourist route for the user. In this regard, server 10 can construct a task command for generating a tourist route based on the planning conditions; initiate a task command to the AI model to control the AI model to generate a tourist route for the user; send the tourist route to the user terminal 20 for display. Among them, the various planning conditions contained in the tourist route planning request can be configured in the task command used to generate the tourist route to control the AI model to discover the combination of tourist attractions that meets the planning conditions for the user and produce the corresponding tourist route.

In summary, the content that can be displayed in the travel service interface in this embodiment can include but is not limited to:
Homepage, providing personalized travel attractions, restaurants, hotels, and other local experience push information. Users can browse, like, or choose;
Tourism attractions search, allows searching and selecting specific tourist attractions, and can also link to the introduction page of the selected tourist attractions;
Interactive map, supports panning and zooming of the map, supports filtering, searching, and clicking to select tourist attractions. Display different levels of well-known attractions. Support displaying additional locations that meet the popular requirements only for selected attractions in the map;
Tourist attractions introduction, summarizing key information such as highlights, history, experiences, and adjusting the summarized key information according to user interests;
Attraction description information, provides more detailed information about tourist attractions, can be generated by an AI model as previously described, and supports customization according to user interests;
Shooting guidance information, can provide scene-specific guidance for taking photos at hotspots locations, and the included shooting techniques;
Social content creation guidance information, can suggest video titles & thumbnails, video scripts, content titles, tweet scripts, blog scripts, and hashtags to inspire users to post content, providing creative inspiration for users;
Itinerary planning tool, helps to formulate a complete tourist route, as previously mentioned, can use an AI model to generate a tourist route for user-specified parameters;
Personal profile, manage account, data and settings, etc., allow management of account details, travel history, saved recommendations, connected accounts, privacy settings, and other personalized preferences.

Of course, the travel service interface in this embodiment can also contain other content, which will not be exhausted here. In this way, the intuitive interface makes it natural and enjoyable for users to interact with various personalized travel recommendations and planning functions, and the operation is also more editorial, thereby effectively improving the user experience.

In the above or the following embodiments, an AI model can be used to generate scenic spot description information, shooting guidance information, and social content creation guidance information for users respectively. The AI model in this embodiment can adopt Generative AI technology. Generative AI technology is a new type of AI technology that uses machine learning technology, especially deep learning models, to generate new original content by learning from large datasets. The content involved can include text, images, music, sounds, or videos. In this way, the AI model in this embodiment can understand the inherent structure and pattern of data, and then create new data that is similar to the reference data. In other words, the AI model can generate new data that looks and sounds similar to the reference data.

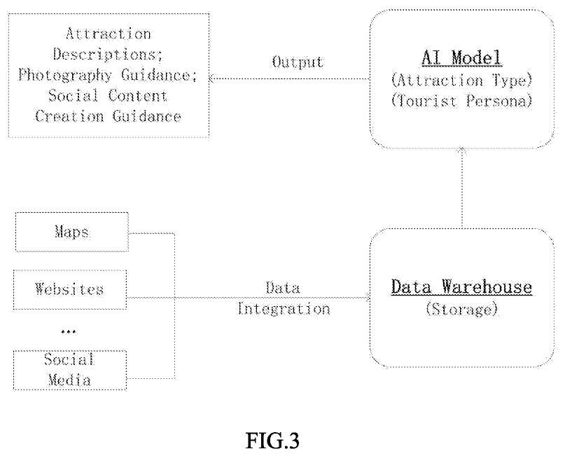

FIG. 3 shows a logical schematic diagram of an implementation plan provided by an exemplary embodiment of this application for generating, for users, description information for tourist attractions, photography guidance information, and social content creation guidance information.

Referring to FIG. 3, on the one hand, the database used by the AI model can be transformed in this embodiment. To this end, in this embodiment, the server can first extract tourist attractions related to geographical location knowledge from websites, and then use other data sources such as map websites to cross-verify the extracted attractions to filter out the correct attractions, which serve as multiple preset attractions. Of course, other methods can be adopted to determine the preset multiple attractions in this embodiment, which is not limited to this.

On this basis, the server can collect reference data for multiple preset attractions from multiple data sources. Referring to FIG. 3, multiple data sources can include map websites, official websites corresponding to multiple attractions, and social media websites. Of course, this is only exemplary, and the server in this embodiment can connect to more data sources. Below are several examples of data sources and a simple explanation of the parameter data collected from the data sources:
The official website of the attraction, authoritative information about the attraction can be collected from it. This includes detailed information about landmarks, historical facts, events, etc.
Map websites, where background information such as locations, opening hours, user reviews, etc., can be collected.
Social media websites, through posts by local residents and tourists, provide insights and examples of travel content about attractions, restaurants, hotels, etc.
Websites for traveler reviews highlight the consumer's perspective and provide consumer opinions on local services such as attractions, hotels, restaurants, etc.
Travel blog websites provide detailed narrative-style narratives related to the attractions, reflecting the experiences of tourists.

It can be seen that the reference data in this embodiment can include but is not limited to official website data, map data, user review data or social media data, etc. collected from the above few exemplary data sources.

On this basis, the server in this embodiment can perform one or more of the following operations to clean and integrate the database used by the AI model:
Aggregate tourism data from different sources, the server can connect to various data sources and aggregate the collected reference data into a processing repository.
Cleaning and normalizing collected reference data, including removing duplicate data, resolving inconsistencies, handling missing data, and standardizing formats, etc.

Annotating reference data with rich tags.
Classifying reference data by attraction name, attraction type, user type, etc.
Structuring the classified reference data into the training format required by the AI model, including but not limited to shaping it into tables, embedding rich features, and configuring model-ready data sets, etc.
Refresh data to keep the model updated, by constantly merging new data to use the latest reference data to refresh the AI model, thereby keeping the AI model's training data updated.

As mentioned earlier, the server can add tags to the collected reference data. The tags include one or more tags of the attraction type and user type. In addition, the attractions can be tagged with an attraction type, and the attraction type can be associated with the collected reference data through the attraction as a medium. Afterwards, the tagged reference data can be added to the database corresponding to the AI model. The types of attractions can include but are not limited to amusement parks, museums, and aquariums, etc. In this way, by adding the tagged reference data to the database corresponding to the AI model, targeted reference knowledge related to the travel service in this embodiment can be provided to the operation of the AI model to improve the accuracy of the results output by the AI model for the travel service in this embodiment.

Referring to FIG. 3, on the other hand, the task instructions for controlling the AI model can be transformed in this embodiment.

For this, in this embodiment, task instruction templates that are not exactly the same can be configured for different attraction types, to control the AI model to execute generation logics that are not exactly the same, so as to generate the required information items for attractions under different attraction types. Among them, one exemplary pre-setting scheme for a task instruction template can be: create to-be-optimized task instructions according to the information items required under the target attraction type, respectively; call the AI model according to the to-be-optimized task instructions corresponding to each information item, respectively; if the output results produced by the AI model for any information item do not meet the preset requirements, adjust the to-be-optimized task instruction corresponding to the information item until the output result corresponding to the information item meets the preset requirements; based on the adjusted task instructions, set the task instruction template corresponding to the information item to obtain the task instruction template under the target attraction type. In this exemplary pre-setting scheme for the task instruction template, the corresponding task instruction can be adjusted in reverse according to the output result of the AI model, and the task instruction template under the target attraction type can be produced after the output result meets the preset requirements.

It should be understood that a single task instruction template in this embodiment can contain multiple task fields, and the field values under the task fields can be dynamically configured according to actual needs to produce the final task instructions for different attractions. The task fields in this embodiment can include but are not limited to instruction fields for configuring task actions, instruction fields for configuring the user type of interest, instruction fields for configuring the degree of interest in user type, or instruction fields for configuring social content styles, etc. Of course, these are only exemplary, and this embodiment is not limited to this.

In addition, in this embodiment, the user end can also respond to the user-initiated travel service evaluation operation to obtain the service evaluation information submitted by the user; send the service evaluation information to the server end. For the server end, it can monitor the improvement suggestion data for travel services under the target attraction type; determine the target task instruction template pointed by the improvement suggestion data detected in the task instruction template under the target attraction type; based on the improvement suggestion data, adjust the target task instruction template again. In this way, the server can continuously optimize the task instruction template in the AI model based on the improvement suggestion data contained in the service evaluation information.

Based on this, the implementation schemes for the server to generate attraction description information, shooting guide information, and social content creation guide information for users are detailed as follows.

1. In this embodiment, the server can generate attraction description information for users based on the target attraction type corresponding to the travel attraction using the AI model.

As mentioned earlier, the attraction types in this embodiment can include but are not limited to natural scenery, cultural landscape, or city exploration. Depending on the different attraction types, the AI model can be controlled to execute slightly different generation logic, thereby generating information items that match the attraction type under various types of information in the attraction description. As mentioned earlier, the attraction description information in this embodiment can include but is not limited to basic information, cultural knowledge, anecdotes, travel tips, user reviews information, recent activity information or nearby locations, etc., and multiple information items can be provided under a single type of information. For example, for natural scenery attractions, travel tips such as the location of cliff edges and turbulent water flows can be provided; for cultural attractions, travel tips for interesting history or hidden locations can be provided. For example, if the travel attraction is Museum A, and there is a terrace in Museum A where you can view the downtown scenery, which is a hidden location, travel tips for this hidden location can be provided in the basic description information generated for the user to indicate the features of this hidden location, etc.

For this purpose, in this embodiment, the server can create a first task instruction set for the travel attraction based on the task instruction template used to generate the attraction description information under the target attraction type corresponding to the travel attraction. As mentioned earlier, the task instruction template provides multiple task fields, here, the task fields of the task instruction template used to generate attraction description information under the target attraction type can be configured to create the first task instruction set for the travel attraction. It should be understood that the configuration operation here can include adding value operation to task fields that lack value or adjusting valve operation to task fields that already have default values. In addition, it should be understood that for different attractions under the target attraction type, the configuration operations performed here can be slightly different to adapt to more specific personalized requirements under different attractions, which are not enumerated here.

In this embodiment, the first task instruction set can include a first task instruction group for generating user evaluation information. The first task instruction group specifies the user type and analysis rules to control the AI model to conduct a comprehensive analysis of the evaluation data for the travel attraction under the specified user type, thereby constructing user evaluation information for the travel attraction. An optimal analysis rule can include a balanced summary of positive and negative evaluation information. In this way, the AI model can consider the perspectives of various user types, including singles, couples, families, etc., to ensure a wide range of experiences, allowing users to understand the travel attraction from the perspective of different user types; and it can integrate positive and negative evaluation information to provide a balanced summary, avoiding conveying one-sided views to users.

In this version, the first set of instructions for the AI assistant can include a second group of instructions for finding nearby locations. This second group specifies that the AI should look for locations near the travel attraction that are highly recommended. The system has popularity scores for each location already set up. Using the first instruction set, the AI can check the scores for various nearby spots the user asked about. It will pick the ones with scores above a certain threshold as the top nearby locations for that attraction. That way the extra location info the AI gives the user will only have these highly rated nearby places.

In addition to the aforementioned requirement, the second set of instruction groups can also specify one or more parameters such as the required geographic range, user type, and location type. The location types in this embodiment can include but are not limited to attractions, restaurants, or hotels, etc., to more reasonably select nearby locations.

In addition, the first set of instruction sets can also include task instructions for generating one or more types of information such as basic information, cultural knowledge, anecdotes, travel tips, and recent activity information. And in these sets of instructions, the user type of concern can also be configured as needed, and the degree of concern for user type can be configured, in order to more reasonably display various types of information in the attraction description information generated for the user.

It should be understood that in practical applications, task instructions from the first task instruction set can be inputted into the AI model one by one to control the AI model to output corresponding information items one by one, thereby generating description information corresponding to the tourist attraction.

Furthermore, in this embodiment, the server can use all the description information generated by the AI model for the tourist attraction as the description information for the tourist attraction generated for the user. In this case, the description information obtained by different users for the same tourist attraction will be identical. In this embodiment, the server can also use part of the destination description information generated by the AI model for the tourist attraction as the description information for the tourist attraction generated for the user. In this case, the description information may include two parts: one part is general information, that is, information common to different users; the other part can be personalized information, which in practical applications can be information that matches the user's user type. In this way, for the same tourist attraction, the description information obtained by different users will differ, and the differing part is the aforementioned personalized information part. For example, for natural attraction type, if the user's user type is a nature lover, in the travel tips section of the description information, in addition to providing general information, special travel tips for nature lovers can also be provided, such as places where slipping is likely to occur, etc. If the user's user type is a family, in the travel tips section of the description information, in addition to providing communication information, special travel tips for families can be provided, such as describing the historical stories that occurred in the tourist attraction according to children's language habits, etc.

It should be understood that since the reference data has been pre-labeled with the types of attractions and user type in this embodiment, by configuring task fields related to user type in the task instructions used to generate description information, the AI model can be controlled to generate more targeted and accurate description information for the user's tourist attractions.

2. In this embodiment, the server can generate shooting guide information for the user based on the target attraction type corresponding to the tourist attraction, using the AI model for the hotspot shooting locations in the tourist attractions.

For this, in this embodiment, the server can create a second task instruction set for the tourist attraction based on the task instruction template for generating shooting guide information under the target attraction type. The second task instruction set includes a third task instruction group for determining hotspot shooting locations and a fourth task instruction group for generating shooting guide information for the determined hotspot shooting locations. Here, the third task instruction group is used to control the AI model to determine hotspot shooting locations for tourist attractions, and the fourth task group is used to generate shooting guide information for the determined hotspot shooting locations.

As mentioned earlier, in this embodiment, social media type reference data for tourist attractions has been obtained in advance. This type of reference data contains shooting knowledge related to tourist attractions. For example, shooting diaries written by professional photographers for tourist attractions. In this embodiment, the AI model can determine feature shooting locations and shooting guide information for these feature shooting locations based on this reference data.

In practical applications, the shooting guide information provided for users in this embodiment is universal, that is, the same shooting guide information can be provided to different users for the same tourist attraction, so that all users will not miss popular shooting locations and can shoot relatively excellent works at popular shooting locations.

The shooting guide information in this embodiment can include but is not limited to landmark names, shooting times or shooting techniques, etc. The landmark names, shooting times or shooting techniques, etc. are all new data generated by the AI model based on the analysis of the reference data, which depends on the reasonable and comprehensive second task instruction set constructed by the server for the tourist attractions. In this embodiment, the server can build the second task instruction set based on the task instruction template for generating shooting guide information under the target attraction type through configuration operations, where the configuration operations can include adding values to task fields with missing values or adjusting the values of task fields with default values, etc.

3. In this embodiment, the server can also generate social content creation guide information for users for tourist attractions based on the target attraction type corresponding to the tourist attraction, using the AI model.

For this, in this embodiment, the server can create a third task instruction set for the tourist attraction based on the task instruction template for generating social content creation guide information under the target attraction type. The third task instruction set is used to call the AI model to control the AI model to generate social content creation guide information for the tourist attractions.

In addition, in this embodiment, part or all of the task instruction templates used to generate social content creation guide information under the target scene include instruction fields for configuring the user type of interest, instruction fields for configuring the degree of attention to the user type, and/or instruction fields for configuring the style of social content.

Based on this, the server can execute configuration operations on the task instruction template for generating social content creation guide information under the target attraction type to create a third task instruction set for the tourist attraction. Here, the configuration operation can include adding values to task fields with missing values or adjusting the values of task fields with default values, etc. In this way, various types of information items that are adapted to different user types can be generated under the social content creation guide information.

Based on this, in this embodiment, the server can determine the information attribute tags preferred by the user. From the social content guidance information constructed for tourist attractions, information that matches the user's preferred information attribute tags is selected to generate creative content guidance information for the tourist attractions for the user. In this case, the server can determine the information attribute tags preferred by the user based on the user's historical travel information and personal attribute information, etc. Of course, users can also directly specify their preferred information attribute tags in the user terminal, and carry the information attribute tags in the travel service request for the server to know. This embodiment does not limit the way in which the server determines the information attribute tags preferred by the user.

In this way, this embodiment can provide personalized social content creation guidance information for different users to more flexibly and accurately adapt to user preferences.

It is known that in this embodiment, when using the AI model to generate attraction description information, shooting guidance information, and social content creation guidance information for tourist attractions, parameters such as attraction type and user type are fully considered to control the AI model to generate targeted, reasonable, objective, and comprehensive information for tourist attractions. And on this basis, the individual needs of different types of users can be considered, and all or part of the information generated by the AI model for tourist attractions can be selected from various service feedback information as the service feedback information generated for users for tourist attractions. This makes the various service feedback information provided to users not lose its personalization.

In summary, in this embodiment, on the one hand, the database used by the AI model has been remodeled, and the reference data collected in this embodiment and precisely labeled is added to the database to provide a more targeted and more accurate knowledge base for the AI model. On the other hand, the task instruction model under different attraction types has been designed and optimized to generate better attraction description information, shooting guidance information, and social content creation guidance information for each attraction.

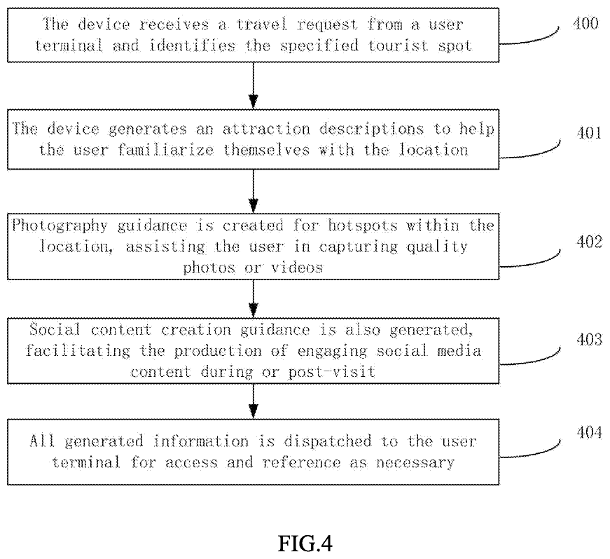

FIG. 4 is a schematic diagram of a process of a travel service method provided by another exemplary embodiment of this application. This method can be executed by a data processing device, which can be implemented as software, hardware, or a combination of software and hardware. The data processing device can be integrated into the server. Referring to FIG. 4, the method includes:

Step 400: The device receives a travel request from a user terminal and identifies the specified tourist spot.

Step 401: Based on the spot's attributes, the device generates a detailed description to help the user familiarize themselves with the location.

Step 402: Shooting guidance is created for hotspots within the location, assisting the user in capturing quality photos or videos.

Step 403: Social content creation guidance is also generated, facilitating the production of engaging social media content during or post-visit.

Step 404: All generated information is dispatched to the user terminal for access and reference as necessary.

In an optional embodiment, the step of generating sightseeing information for a tourist attraction for a user includes:
Generating sightseeing information for the tourist attraction for the user based on the target attraction type corresponding to the tourist attraction, using an AI model.

In an optional embodiment, the step of generating sightseeing information for the tourist attraction for the user using an AI model based on the target attraction type corresponding to the tourist attraction includes:
Creating a first set of task instructions for the tourist attraction based on the task instruction template for generating sightseeing information under the target attraction type. The first set of task instructions is used to call the AI model to generate sightseeing information for the tourist attraction;
Part or all of the descriptive information generated by the AI model for the tourist attraction is used as the sightseeing information generated for the user.

In an optional embodiment, the first set of task instructions includes a first group of task instructions for generating user evaluation information. The first group of task instructions specifies the user type and analysis rules to control the AI model to conduct a comprehensive analysis of the evaluation data for the tourist attraction under the specified user type, in order to construct user evaluation information for the tourist attraction;

The analysis rules include balanced overviews of positive and negative evaluation information.

In an optional embodiment, the first set of task instructions contains a second group of task instructions, which specify requirements for the location to control the AI model to filter out nearby locations that exceed the specified popularity standard for the tourist attraction;

The sightseeing information generated for the user includes the filtered nearby locations, for display on the user end.

In an optional embodiment, the step of generating shooting guidance information for a hotspot shooting location within the tourist attraction for the user includes:
Generating shooting guidance information for the user for the hotspot shooting location within the tourist attraction based on the target attraction type corresponding to the tourist attraction, using an AI model.

In an optional embodiment, the step of generating shooting guidance information for the user for the hotspot shooting location within the tourist attraction using an AI model based on the target attraction type corresponding to the tourist attraction includes:
Creating a second set of task instructions for the tourist attraction based on the task instruction template for generating shooting guidance information under the target attraction type. The second set of task instructions contains a third group of task instructions for determining hotspot shooting locations and a fourth group of task instructions for generating shooting guidance information for the determined hotspot shooting locations;
The third group of task instructions is used to control the AI model to determine the hotspot shooting locations for the tourist attraction, and the fourth group of task instructions is used to generate shooting guidance information for the determined hotspot shooting locations.

In an optional embodiment, the step of generating social content creation guidance information for a tourist attraction for a user includes:
Generating social content creation guidance information for the user for the tourist attraction based on the target attraction type corresponding to the tourist attraction, using an AI model;
Some or all of the task instruction templates for generating social content creation guidance information under the target attraction type contain instruction fields for configuring the user type of concern, instruction fields for configuring the degree of attention to user types, and/or instruction fields for configuring social content styles.

In an optional embodiment, the method may also include:
Determining the user type and geographical location corresponding to the user;
Determining the target tourist attraction that the user is interested in based on the user type and location from multiple preset attractions;
Generating push information for the user for the target tourist attraction;
Pushing the push information to the user end for display.

In an optional embodiment, if the attraction type corresponding to the attraction is a natural scenery, its corresponding push information is configured with historical anecdotes and/or famous quotes related to the attraction; if the attraction type corresponding to the attraction is cultural or urban exploration, its corresponding push information is configured with recommended activity description information and/or a brief introduction of the attraction.

In an additional option, the method can also:
Calculate popularity scores for each of the predefined travel attractions.
Differentiate between attractions of varying popularity levels in the travel map component. When the user views the map page and calls up the map component, attractions are displayed differently based on their popularity score. More popular spots are highlighted or marked differently than less popular ones.

In this way, the travel map shows the user information about how popular each attraction is when they look at the locations.

In an optional embodiment, the method may also include:
In response to a travel route planning request initiated by the user end, determining the planning conditions provided by the user, where the planning conditions include one or more conditions such as attraction type, user type, geographical area, and travel duration;
Based on the planning conditions, constructing task instructions for generating a travel route;
Sending task instructions to the AI model to control the AI model to generate a travel route for the user;
Sending the travel route to the user end for display.

In an optional embodiment, the information formats of the sightseeing information, shooting guidance information, and social content creation guidance information adopt a combination of one or more formats of text, graphics, and videos; the attractions information contains one or more types of information such as basic information, cultural knowledge, anecdotes, travel tips, user evaluation information, recent activity information, and nearby locations;

The shooting guidance information contains one or more types of information such as landmark name, shooting time, and shooting techniques;

The social content creation guidance information contains one or more types of information such as video titles & thumbnails, video scripts, content titles, tweet scripts, blog scripts, and hashtags.

It's worth noting that the technical details in each of the embodiments about the travel service method can refer to the related descriptions about the server in the system embodiment mentioned above. To save space, they are not repeated here, but this should not cause any loss to the scope of protection of this application.

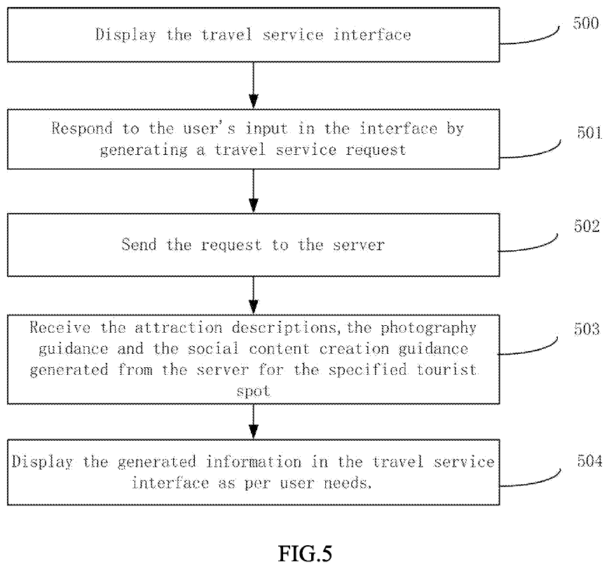

FIG. 5 shows a flowchart of another method for providing tourism services offered in another exemplary embodiment of this application. The method can be executed by a data processing device, which can be implemented as software, hardware, or a combination of software and hardware. The data processing device can be integrated into the user end. Referring to FIG. 5, the method includes:

Step 500: Display the travel service interface.

Step 501: Respond to the user's input in the interface by generating a travel service request.

Step 502: Send the request to the server.

Step 503: Receive the attraction descriptions, the photography guidance and the social content creation guidance generated from the server for the specified tourist spot.

Step 504: Display the generated information in the travel service interface as per user needs.

In an optional embodiment, the method may also include:
Displaying a tourist attraction input control in the tourism service interface;
Using user input operations executed on the tourist attraction input control as the tourist attraction configuration operations; and/or,
Displaying push notifications from the server to the user via the tourism service interface;
Using user operations executed on the push notifications as the tourist attraction configuration operations; and/or,
Sending a request to the server to call up a tourism map component, to display a tourism map page provided by the tourism map component via the tourism service interface. The tourism map page contains tourist attractions of different levels of popularity, marked distinctly;
Using user operations executed on the tourism map page as the tourist attraction configuration operations.

It is worth mentioning that the technical details in the above embodiments of the tourism service method can refer to the related descriptions about the user end in the aforementioned system embodiments. To save space, they will not be repeated here, but this should not lead to the loss of the scope of protection of this application.

It should be noted that in some of the processes described in the above embodiments and figures, there are multiple operations appearing in a specific order. However, it should be clear that these operations can be executed or parallelly executed in an order different from their appearance in this text. Operation numbers such as 501, 502, etc., are only used to distinguish different operations, and the numbers themselves do not represent any execution order. In addition, these processes may include more or fewer operations, and these operations can be executed in order or parallel. It should be noted that the descriptions of “first”, “second”, etc. in this text are used to distinguish different sets of task instructions, groups of task instructions, etc., and do not represent the order of occurrence, nor do they limit “first” and “second” to different types.

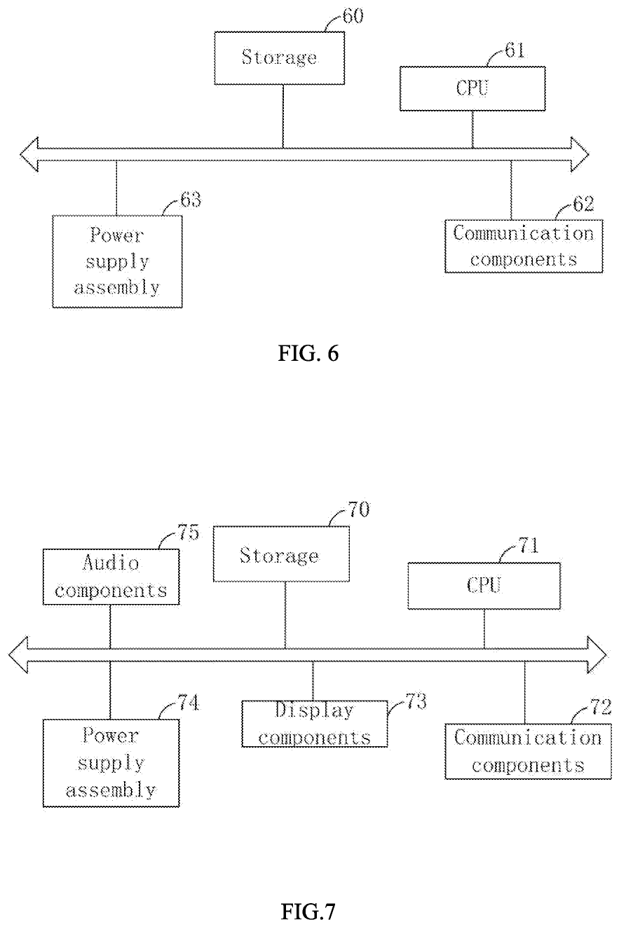

FIG. 6 is a schematic diagram of the structure of a computing device provided by another exemplary embodiment of this application. As shown in FIG. 6, the computing device may include: a storage unit 60, a processor 61, and a communication component 62.

The processor 61, coupled with the storage unit 60 and the communication component 62, is used to execute the computer program in the storage unit 60 for:
Responding to a tourism service request initiated by the user end, and determining the tourist attractions requested by the user;
Generating description information of the tourist attractions for the user to familiarize themselves with the tourist attractions before the start of the tour;
Generating shooting guide information for hot shooting spots in the tourist attractions to guide users to take photos of the hotspots during the tour;
Generating social content creation guide information for the tourist attractions for the user, to guide the user to create target social content corresponding to the tourist attractions during or after the tour;
Utilizing the communication component 62 to send the attraction description information, shooting guide information, and social content creation guide information to the user end according to the user's needs for the user to view as needed.

In an optional embodiment, when the processor 61 generates description information of the tourist attractions for the user, it can be specifically used to:
Generate description information of the tourist attractions for the user based on the target attraction type corresponding to the tourist attractions, using an AI model.

In an optional embodiment, when the processor 61 generates description information of the tourist attractions for the user based on the target attraction type corresponding to the tourist attractions using an AI model, it can be specifically used to:
Create a first task instruction set for the tourist attractions based on the task instruction template used for generating description information under the target attraction type, where the first task instruction set is used to call the AI model to control the AI model to generate description information of the tourist attractions;
Use part or all of the destination description information generated by the AI model for the tourist attractions as the description information generated for the user regarding the tourist attractions.

In an optional embodiment, the first task instruction set includes a first task instruction group used to generate user evaluation information, the first task instruction group specifies the user type and analysis rules, to control the AI model to conduct a comprehensive analysis of the evaluation data of the tourist attractions under the specified user type according to the analysis rules, to construct user evaluation information for the tourist attractions;
Where, the analysis rules include a balanced summary of positive and negative review information.

In an optional embodiment, the first task instruction set includes a second task instruction group, the second task instruction group specifies the popularity requirement for the location, to control the AI model to filter out nearby locations that meet the popularity requirement for the tourist attractions;
Where, the description information generated for the user includes the filtered nearby locations, for display at the user end.

In an optional embodiment, when the processor 61 generates shooting guide information for the user for hot shooting spots in the tourist attractions, it can be specifically used to:
Generate shooting guide information for hot shooting spots in the tourist attractions for the user based on the target attraction type corresponding to the tourist attractions, using an AI model.

In an optional embodiment, when the processor 61 generates shooting guide information for the user for hot shooting spots in the tourist attractions based on the target attraction type corresponding to the tourist attractions using an AI model, it can be specifically used to:
Create a second task instruction set for the tourist attractions based on the task instruction template used for generating shooting guide information under the target attraction type, the second task instruction set includes a third task instruction group used to determine hot shooting spots and a fourth task instruction group used to generate shooting guide information for the determined hot shooting spots;
Where, the third task instruction group is used to control the AI model to determine hot shooting spots for the tourist attractions, the fourth task group is used to generate shooting guide information for the determined hot shooting spots.

In an optional embodiment, when the processor 61 generates social content creation guide information for the user for the tourist attractions, it can be specifically used to:
Generate social content creation guide information for the user for the tourist attractions based on the target attraction type corresponding to the tourist attractions, using an AI model;
Where, part or all of the task instruction templates used to generate social content creation guide information under the target attraction type include instruction fields used to configure the user type of interest, instruction fields used to configure the attention level to the user type, and/or instruction fields used to configure the style of the social content.

In one optional implementation, processor 61 may also be used to:
Determine the user type and geographical location corresponding to the user;
Based on the user type and location, determine the target tourist attraction that the user is interested in from the preset multiple attractions;
Generate push information for the user targeting the desired attraction;
Push the information to the user side for display.

In another optional implementation, if the attraction type corresponding to the attraction is a natural landscape, the corresponding push information is configured with historical anecdotes and/or famous quotes related to the said attraction; if the attraction type corresponding to the attraction is cultural or urban exploration, the corresponding push information is configured with the description of recommended activities and/or brief information about the said attraction.

In yet another optional implementation, processor 61 may also be used to:
Determine the popularity level for each of the preset attractions;
In the tourism map component, differentiate and mark attractions of different popularity levels, so that different levels of attractions can be displayed differently when the user calls up the tourism map component through the tourism map page.

In another optional implementation, processor 61 can also be used to:
In response to the travel route planning request initiated by the user side, determine the planning conditions provided by the user, which include one or more conditions from attraction type, user type, geographical area, and travel duration;
Based on the planning conditions, construct task instructions for generating travel routes;
Launch task instructions to the AI model, to control the AI model to generate travel routes for the user;
Send the travel route to the user side for display.

In yet another optional implementation, the information format of attraction description information, shooting guidance information, and social content creation guidance information adopts a combination of one or more formats from text, graphics, and video; the attraction description information contains one or more types of information from basic information, cultural knowledge, fun facts, travel tips, user review information, recent activity information, and nearby location information;

The shooting guidance information contains one or more types of information from landmark names, shooting times, and shooting techniques;

The social content creation guidance information includes one or more types of information from video titles & thumbnails, video scripts, content titles, tweet scripts, blog scripts, and hashtags.

Furthermore, as shown in FIG. 6, the computing device also includes other components such as a power component 63. FIG. 6 only gives a suggestive representation of some components and does not imply that the computing device includes only the components shown in FIG. 6.

It should be noted that the technical details of each implementation of the computing device as described above can refer to the previous system implementation about the server side description to save space. This should not result in a loss to the protection scope of this application.

FIG. 7 shows a schematic diagram of the structure of another computing device provided by another exemplary embodiment of this application. As shown in FIG. 7, the computing device may include: memory 70, processor 71, communication component 72, and display component 73.

The processor 71 is coupled with the memory 70, communication component 72, and display component 73 to execute computer programs in the memory 70, for:
Displaying a travel service interface through the display component 73;
In response to the travel attraction configuration operation executed by the user in the travel service interface, generate a travel service request;
Sending the travel service request to the server through the communication component 72;
Receiving from the server via communication component 72, the attraction description information, shooting guidance information, and social content creation guidance information generated for the user for the travel attraction;
Using the travel service interface to display the attraction description information, the shooting guidance information, and the social content creation guidance information according to the user's needs.

In an optional embodiment, the processor 71 can also be used to:
Display a travel attraction input control in the travel service interface;
The input operation executed by the user on the travel attraction input control is treated as the travel attraction configuration operation; and/or,
Use the travel service interface to display the push information provided by the server to the user;
The scenic spot selection operation executed by the user in the push information is regarded as the travel scenic spot configuration operation; and/or,
Send a call request for the travel map component to the server to display the travel map page provided by the travel map component through the travel service interface. The travel map page includes attractions of different popular levels marked differently;
The scenic spot selection operation executed by the user on the travel map page is regarded as the travel attraction configuration operation.

Furthermore, as shown in FIG. 7, the computing device also includes: power component 74, audio component 75, and other components. FIG. 7 only gives some components schematically and does not mean that the computing device only includes the components shown in FIG. 7.

It is worth noting that the technical details in the various embodiments of the computing device can refer to the relevant descriptions about the user end in the aforementioned system embodiments. To save space, they will not be repeated here, but this should not result in a loss of the scope of protection of this application.

Correspondingly, this application also provides a computer-readable storage medium storing a computer program, which can realize the steps executed in the method embodiment when executed.

The memory in FIGS. 6 and 7 is used to store computer programs and can be configured to store various other data to support operations on the computing platform. Examples of this data include instructions for any application or method operated on a computing platform, contact data, phone book data, messages, pictures, videos, etc. The memory can be implemented by any type of volatile or non-volatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disc.

The communication component in FIGS. 6 and 7 is configured to facilitate wired or wireless communication between the device where the communication component is located and other devices. The device where the communication component is located can access wireless networks based on communication standards, such as WiFi, 2G, 3G, 4G/LTE, 5G and other mobile communication networks, or their combination. In one exemplary embodiment, the communication component receives broadcast signals or broadcast-related information from an external broadcast management system via a broadcast channel. In one exemplary embodiment, the communication component also includes a near field communication (NFC) module to facilitate short-range communication. For example, the NFC module can be based on radio frequency identification (RFID) technology, Infrared Data Association (IrDA) technology, Ultra-wideband (UWB) technology, Bluetooth (BT) technology, and other technologies.

The display component in FIG. 7 includes a screen, which can include a liquid crystal display (LCD) and a touch panel (TP). If the screen includes a touch panel, the screen can be implemented as a touchscreen to receive input signals from the user. The touch panel includes one or more touch sensors to sense touch, slide, and gestures on the touch panel. The touch sensor can not only detect the boundary of the touch or sliding action, but also detect the duration and pressure associated with the touch or sliding operation.

The power component in FIGS. 6 and 7 provides power to various components of the device where the power component is located. The power component can include a power management system, one or more power supplies, and other components associated with generating, managing, and distributing power for the device where the power component is located.

The audio component in FIG. 7 can be configured to output and/or input audio signals. For example, the audio component includes a microphone (MIC), when the device where the audio component is located is in an operation mode, such as call mode, recording mode, and voice recognition mode, the microphone is configured to receive external audio signals. The received audio signals can be further stored in the memory or sent via the communication component. In some embodiments, the audio component also includes a speaker for outputting audio signals.

It should be understood by those skilled in the art that the embodiments of this application can be provided as a method, system, or computer program product. Therefore, this application can be in the form of a completely hardware embodiment, a completely software embodiment, or a combination of software and hardware aspects. Moreover, this application can take the form of a computer program product implemented on one or more computer-usable storage media (including but not limited to magnetic disk storage, CD-ROM, optical storage, etc.) containing computer-usable program code.

This application is described in reference to the flow charts and/or block diagrams of methods, devices (systems), and computer program products according to embodiments of this application. It should be understood that each flow and/or box in the flow charts and/or block diagrams, and combinations of flows and/or boxes in the flow charts and/or block diagrams, can be implemented by computer program instructions. These computer program instructions can be provided to a processor of a general computer, a special computer, an embedded processor, or other programmable data processing device to produce a machine, so that the instructions executed by the computer or other programmable data processing device processor produce a device used to implement the function specified in one or more flows or boxes in the flowchart and/or block diagram.

These computer program instructions can also be stored in computer-readable storage that can guide a computer or other programmable data processing device to work in a specific way, so that the instructions stored in the computer-readable storage generate a product that includes an instruction device. This instruction device implements the function(s) specified in one or more processes and/or block(s) in the flowchart. These computer program instructions can also be loaded onto a computer or other programmable data processing device, so that a series of operation steps are performed on the computer or other programmable device to produce computer-implemented processing, thus the instructions executed on the computer or other programmable device provide steps for implementing the function(s) specified in one or more processes and/or block(s) in the flowchart.

It also needs to be explained that the terms “including”, “containing”, or any other variants thereof are intended to cover non-exclusive inclusion, so that a process, method, product or device that includes a series of elements not only includes those elements, but also includes other elements not explicitly listed, or even includes elements inherent to such a process, method, product or device. Without further restriction, the element defined by the statement “includes a . . . ” does not exclude the existence of other same elements in the process, method, product or device that includes the mentioned element.

The above are only embodiments of this application and are not intended to limit this application. For those skilled in the art, this application can have various changes and modifications. Any modifications, equivalent replacements, improvements, etc., made within the spirit and principles of this application should be included within the scope of protection of this application.

The invention claimed is:

1. A method for providing travel services, applied on the server side, comprising:
Responding to a travel service request initiated by the user terminal, and determining the tourist attractions requested by the user;
Generating attraction descriptions for the user regarding the tourist attractions, for the user to learn about the attractions before starting the trip;
For hotspots within the tourist attractions, generating photography guidance for the user, to instruct the user to take photos of the hotspots during the trip;
Generating social media content creation guidance for the user regarding the tourist attractions, to guide the user to create targeted social media content corresponding to the attractions during or after the trip;
Sending the attraction descriptions, photography guidance, and social media content creation guidance to the user terminal according to the user's needs, for the user's on-demand viewing.

2. The method according to claim 1, wherein generating attraction descriptions for the user regarding the tourist attractions comprises:
Generating attraction descriptions for the user regarding the tourist attractions based on the target attraction type corresponding to the tourist attractions, using an AI model.

3. The method according to claim 2, wherein generating attraction descriptions for the user regarding the tourist attractions based on the target attraction type corresponding to the tourist attractions using an AI model, comprises:
Creating a first task instruction set for the tourist attractions based on the task instruction template used for generating attraction descriptions under the target attraction type, wherein the first task instruction set is used to call the AI model to control the AI model to generate attraction descriptions for the tourist attractions;
Using part or all of the attraction descriptions generated by the AI model for the tourist attractions as the attraction descriptions generated for the user regarding the tourist attractions.

4. The method according to claim 3, wherein the first task instruction set contains a first task instruction group for generating user evaluation information, the first task instruction group specifies the user type and analysis rules to control the AI model to conduct an analysis of the evaluation data for the tourist attractions under the specified user type according to the analysis rules, in order to construct user evaluation information for the tourist attractions;
Wherein the analysis rules include a balanced overview of positive and negative evaluation information.

5. The method according to claim 3, wherein the first task instruction set contains a second task instruction group for generating nearby locations, the second task instruction group specifies popularity requirements for locations, to control the AI model to filter out nearby locations that meet the popularity requirements for the tourist attractions;
Wherein the attraction descriptions generated for the user contain the filtered nearby locations, for display at the user terminal.

6. The method according to claim 1, wherein generating photography guidance for the user for hotspots within the tourist attractions comprises:
Generating photography guidance for the user for hotspots within the tourist attractions based on the target attraction type corresponding to the tourist attractions, using an AI model.

7. The method according to claim 6, wherein generating photography guidance for the user for hotspots within the tourist attractions based on the target attraction type corresponding to the tourist attractions using an AI model, comprises:
Creating a second task instruction set for the tourist attractions based on the task instruction template used for generating photography guidance under the target attraction type, the second task instruction set contains a third task instruction group for determining hotspot photography locations and a fourth task instruction group for generating photography guidance for the determined hotspot photography locations;
Wherein the third task instruction group is used to control the AI model to determine hotspot photography locations for the tourist attractions, and the fourth task instruction group is used to generate photography guidance for the determined hotspot photography locations.

8. The method according to claim 1, wherein generating social media content creation guidance for the user regarding the tourist attractions comprises:
Generating social media content creation guidance for the user regarding the tourist attractions based on the target attraction type corresponding to the tourist attractions, using an AI model;
Wherein the task instruction templates used to generate part or all of the social media content creation guidance under the target attraction type contain instruction fields for configuring the user type of concern, instruction fields for configuring the degree of attention to the user type, and/or instruction fields for configuring the style of the social media content.

9. The method according to claim 8, wherein generating social media content creation guidance for the user regarding the tourist attractions based on the target attraction type corresponding to the tourist attractions using an AI model, comprises:
Constructing social media content creation guidance for the tourist attractions based on the target attraction type corresponding to the tourist attractions, using the AI model;
Obtaining the information attribute tags preferred by the user based on the user's historical travel information and personal attribute information;
Selecting information matching the user's preferred information attribute tags from the constructed social media content guidance for the tourist attractions, to generate creative content guidance for the tourist attractions for the user.

10. The method according to claim 1, further comprising:
Determining the user type and geographical location corresponding to the user;
Based on the user type and geographical location, determining the target attraction that the user is interested in from multiple presets;
Generating push notifications targeting the determined attraction for the user;
Pushing the notifications to the user terminal for display.

11. The method according to claim 10, wherein If the attraction type corresponding to the target attraction is natural scenery, the corresponding push notification contains historical anecdotes and/or famous quotes related to the attraction;
If the attraction type corresponding to the target attraction is humanistic or city exploration, the corresponding push notification contains description of recommended activities and/or brief introductions about the attraction.

12. The method according to claim 1, further comprising:
Determining popularity levels for each of the preset attractions;
Marking attractions of different popularity levels distinctly in the travel map component, so that when the user calls up the travel map component, attractions of different popularity levels can be displayed differently via the travel map page.

13. The method according to claim 1, further comprising:
Responding to a travel route planning request initiated by the user terminal, determining the planning conditions provided by the user, wherein the conditions include one or more of: attraction type, user type, geographic region, attractions visited, travel duration;
Based on the planning conditions, constructing task instructions for generating travel routes;
Launching the task instructions to the AI model, to control the AI model to generate travel routes for the user;
Sending the generated routes to the user terminal for display.

14. The method according to claim 1, wherein the formats of the attraction descriptions, photography guidance, and social media content creation guidance adopt single or combined formats of text, graphics, and video;
The attraction descriptions contain one or more types of information including basic information, cultural knowledge, fun facts, tips, user reviews, recent activities, and nearby locations;
The photography guidance contains one or more types of information including landmark names, shooting times, and shooting techniques;
The social media content creation guidance contains one or more types of information including video titles & thumbnails, video scripts, content titles, tweet scripts, blog scripts, and hashtags.

15. A travel service method applied on the user terminal, comprising:
Displaying a travel service interface;
In response to the travel attraction configuration operation executed by the user in the travel service interface, generating a travel service request;
Sending the travel service request to the server;
Receiving from the server the attraction descriptions, photography guidance, and social media content creation guidance generated for the user regarding the tourist attractions;
Displaying the received attraction descriptions, photography guidance, and social media content creation guidance in the travel service interface as needed by the user.

16. The method according to claim 15, further comprising:
Displaying a travel attraction input control in the travel service interface;
Treating input operations executed by the user on the travel attraction input control as travel attraction configuration operations; and/or,
Displaying push notifications from the server to the user via the travel service interface;
Treating attraction selection operations executed by the user on the push notifications as travel attraction configuration operations; and/or,
Sending a request to the server to invoke the travel map component, to display the travel map page provided by the travel map component via the travel service interface, wherein attractions of different popularity levels are distinctively marked on the travel map page;
Treating attraction selection operations executed by the user on the travel map page as travel attraction configuration operations.

17. A computing device, comprising a storage unit, a processor, and a communication component;
The storage unit stores one or more computer instructions;
The processor, coupled with the storage unit and communication component, executes the one or more computer instructions for:
Responding to a travel service request initiated by the user terminal, and determining the tourist attractions requested by the user;
Generating attraction descriptions for the user regarding the tourist attractions, for the user to learn about the attractions before starting the trip;
For hotspots within the tourist attractions, generating photography guidance for the user, to instruct the user to take photos of the hotspots during the trip;
Generating social media content creation guidance for the user regarding the tourist attractions, to guide the user to create targeted social media content corresponding to the attractions during or after the trip;
Sending the attraction descriptions, photography guidance, and social media content creation guidance to the user terminal according to the user's needs, for the user's on-demand viewing.
